(19) United States
(12) Patent Application Publication
(10) Pub. No.: US 2022/0154924 A1
(43) Pub. Date: May 19, 2022

(54) BEVERAGE RECEPTACLE LIGHT ASSEMBLY

(71) Applicant: LARNAT COMPANIES INCORPORATED, LLC, Medina, OH (US)

(72) Inventors: Myron Eugene BODNAR, Medina, OH (US); Martha Ann BODNAR, Medina, OH (US)

(73) Assignee: LARNAT COMPANIES INCORPORATED, LLC, Medina, OH (US)

(21) Appl. No.: 17/525,083

(22) Filed: Nov. 12, 2021

Related U.S. Application Data
(60) Provisional application No. 63/113,383, filed on Nov. 13, 2020.

(51) Int. Cl. F21V 33/00; F21V 23/04; F21V 31/00; A47G 19/22; B65D 51/24

(52) U.S. Cl. CPC F21V 33/0036; F21V 23/0492; F21Y 2115/10; A47G 19/2227; B65D 51/248; F21V 31/005

(57) ABSTRACT

This invention is directed to lighting apparatus having a gravity switch that is attached to the lid of a beverage container. The light is on when the lid is closed thus lighting the beverage from the top. This is particularly enjoying when the beverage is colored carbonated such as beer with the light interacts with the bubbles of carbonation.

### CROSS REFERENCES AND PRIORITIES

This application claims priority from U.S. Provisional Application No. 63/113,383 filed on 13 Nov. 2020, the teachings of which are incorporated herein in their entirety.

### BACKGROUND

Lighted beverage cups are known in the art. However, these lights are located in the base so that they can shine the light “up” into the liquid.

U.S. Pat. No. 8,919,981 provides a cup with twinkling light effects, primarily comprising an inner cup, an outer cup, and a light unit, with the lower half of the inner cup having a number of arched convex strips, and the base of which has diamond-facet of concave and convex cones. As a result, when the light unit at the base of the outer cup is activated, the effects of the arched convex strips and diamond facets cause the cup to produce numerous refractions of the light source, creating twinkling rays of light with dazzling variation. As noted, the light is at the base and shines up.

U.S. Pat. No. 5,070,435 discloses a drinking glass with an upper cup and supporting stem uses light emitting diodes mounted in recesses on the face of the cup in parallel with a light bulb mounted in the stem adjacent to the cup to provide illumination. A battery, switch and flasher mounted in the stem permits selection of on, off, or flashing options for this illumination. Designs can be cut into the face of the cup about any light emitting diode with fiber optics mounted within these designs to conduct light from the diode throughout the design. Again, this light is underneath the cup and shines up.

U.S. Pat. No. 5,624,177 discloses an illuminated circular ring which provides lumination to various style drinking glasses. This ring being attachable or interdesigned into various style drinking glasses providing a housing for an integrated circuit board with state of the art surface mount solid state components. The components being attached to an interchangeable cover. This ring being considerably narrower than prior art; and works particularly well with a long completely hollow stem high foot champagne style glass. A glass in which the colored light gives to the bubbles of champagne or sparkling beverages a specially pleasing effect. All in an appropriate lightweight state of the art design. Again, as shown in U.S. Pat. No. 5,624,177, the light is in the base shining up the stem of the champagne style glass and into the cup cavity.

U.S. Pat. No. 8,777,440 is to an illuminated, color-changing, interchangeable drinking vessel assembly that includes an upper fluid retaining vessel, a neck, a collar on a stem, and a base. Magnets are located in the neck of the upper fluid retaining vessel and light emitting diodes (SMD LED's) and a magnetically actuated switch are located in the collar of the stem. A controller and battery are located in the base of the stem and are also electrically connected to the light emitting diodes. When the upper fluid retaining vessel and neck are magnetically attached to the collar of the stem, the magnetically operated switch detects the magnetic field and closes the circuit, activating the SMD LED's. Again, the light is at the base.

U.S. Pat. No. 9,186,005 is to a luminescent vessel for containment of drink and its accompanying luminescent coaster base, each provided with bands of energy absorbing photo-luminescent material, emit bright and long-lasting luminescent light making both the vessel and coaster base visible for hours when in a darkened environment. This visibility during the dark makes it possible that a sleeping person, awakening and desiring liquid, can see the nearby vessel, take it from the coaster base, use the vessel, and then return it securely to the illuminated coaster base without incident of spill or disturbance of the darkened environment. While this disclosure makes the vessel a light source, it is does not disclose a light shining into the vessel from the top.

U.S. Pat. No. 10,226,141 discloses an apparatus which can include a generally planar portion approximately in a plane. The apparatus can also include a lip portion extending in a direction generally orthogonal to the plane. The generally planar portion is joined to the lip portion at a circumferential edge of the generally planar portion to form a cover for a beverage receptacle. Likewise, a method can include providing contact information on a disposable cover adapted to cover a beverage receptacle. The contact information is not necessarily provided by the manufacturer of the beverage or beverage receptacle. The method can also include receiving contact from a user of the disposable cover. The method can further include coordinating the delivery of a service to the user of the disposable cover responsive to the contact received from the user. The patent discloses that the disposable cover may have an ultraviolet sterilization light.

The problem in the prior art is that all the lights require manually turning them on or off. There exists therefore for an automatic lighting device which turns itself on and off.

### SUMMARY

This specification discloses a lighting apparatus comprising a power source; at least one light source; a gravity switch having an on positional status and an off positional status; wherein the power source, the light source, and the gravity switch are electrically connected so that the light source emits wavelengths in the visible spectrum when the gravity switch is in the on positional status.

The specification further disclose that the gravity switch comprises a ball inside a tube wherein the ball has a position in the tube relative to a force of gravity.

It is further disclosed that the ball may not be magnetic.

It is further disclosed that the lighting apparatus may be enclosed in an enclosure as a lighting assembly. This enclosure may comprise a face, a base and at least one wall connecting the face and the back wherein at least a portion of the wavelengths emitted from the light source pass through the face and/or the at least one wall and the gravity switch is in the on positional status.

In one embodiment the enclosure is water resistant at a submersible pressure which may be at least 1 inch of water.

It is also disclosed that the at least one light source may be a light emitting diodes (LED). which may be selected from the group consisting of white, single-colored, flickering (candle like), and multi-colored.

In one embodiment there is a magnet attached to the base and the position of the ball in the tube during the on positional status is not affected by the magnet, i.e., the ball is not magnetic.

It is further described that the base of the enclosure may be attached to a lid of a beverage receptacle.

It is further disclosed that the lid has a horizontal closed position and a vertical open position, and the gravity switch is in the on positional status when the lid is in the horizontal closed position and the gravity switch is in the off positional status when the lid is in the horizontal closed position.

It is also disclosed that the base of the enclosure may be magnetically attached to the lid. This may be accomplished by placing the lid between the magnet attached to the base of the enclosure and a magnet on a side of the lid opposite the enclosure.

It is also disclosed that the magnet on the side of the lid opposite the enclosure is attached to a cap bearing a promotional demarcation.

Alternatively, the base of the enclosure is affixed to the lid means such as welding, gluing, curing, and suction.

The base of the enclosure further may alternatively comprise a threaded post passing through a hole in the lid and secured with a mated thread device.

Alternatively, the base of the enclosure and the lid may be of unitary construction, such as injection molded in one part.

The lid is further attached to a handle of the beverage enclosure. The beverage receptacle is a stein and/or selected from the group consisting of mugs, glasses, and cups.

### BRIEF DESCRIPTION OF FIGURES

FIG. 1 depicts the components of an embodiment of the lighting apparatus.

FIG. 2 depicts the assembled components of an embodiment of the lighting apparatus.

FIG. 3A depicts the assembled components of an embodiment of the lighting apparatus with a gravity switch in its positional off status relative to the force of gravity.

FIG. 3B depicts the assembled components of an embodiment of the lighting apparatus with a gravity switch in its positional on status relative to the force of gravity

FIG. 4 depicts an embodiment of a lighting assembly.

FIG. 5A depicts a base half and a top half of the enclosure of an embodiment of the lighting assembly.

FIG. 5B depicts the assembled enclosure of an embodiment of the lighting assembly.

FIG. 6 depicts individual components of accessories to modify the beverage receptacle.

FIG. 7 depicts an embodiment of a beverage receptacle with the lighting assembly and lighting apparatus attached.

FIG. 8 depicts an embodiment of lighting assembly and lighting apparatus attached to a lid of a beverage receptacle.

FIG. 9A depicts a different embodiment of a different beverage receptacle with the lighting assembly and lighting apparatus attached to the lid.

FIG. 9B is the cross-sectional view of a beverage receptacle with the lighting assembly and lighting apparatus attached to the lid.

FIG. 10 depicts a disassembled embodiment of the invention.

FIG. 11 depicts an assembled embodiment of the invention.

FIG. 12 is a top view of the assembled embodiment of the invention.

FIG. 13 depicts the inside view of the lid of the assembled embodiment of the invention.

FIG. 14 depicts a separate embodiment of the invention with a removable beverage storage component.

FIG. 15 depicts a separate embodiment of the invention with a removable beverage storage component with the removable storage component is inserted in place.

FIG. 16 depicts an embodiment of the invention with a hole in the lid of the beverage receptacle and ornamental features on the wall of the beverage receptacle.

### DETAILED DESCRIPTION

Disclosed herein is a lighting apparatus which is a gravity actuated light cover for a beverage receptacle. The light cover is described below with reference to the Figures. As described herein and in the claims, the following numbers refer to the following structures as noted in the Figures.
100 is the lighting apparatus.
110 is a holder for a battery and is part of the wired connections.
111 is a first holder lead.
112 is a second holder lead.
114 is the light side of the lighting apparatus.
115 is the base side of the lighting apparatus.
130 is a light source.
131 is a first light source lead.
132 is a second light source lead.
140 is a gravity switch having an on positional status and an off positional status.
141 is a gravity switch first lead.
142 is a gravity switch second lead.
145 is a ball which moves relative to the force of gravity which places the gravity switch in a positional on or positional off status.
150 is a lighting assembly.
151 is the wall of an enclosure of the lighting assembly.
152 is the top half of the enclosure of the lighting assembly.
153 is the face of the enclosure.
154 is the base half of the enclosure of the lighting assembly.
155 are threads on the base half of the enclosure.
156 is an O-ring forming a seal between the top half of the enclosure and the base half of the enclosure.
158 is a magnet affixed to the base half of the enclosure.
159 is an enclosure for the lighting apparatus.
300 is a magnet.
400 is an ornamental device.
500 is a beverage receptacle.
550 is the lid to go on top of the beverage receptacle.
551 is a hole in the lid of the beverage receptacle.
552 is a lever which when pushed causes the lid to raise from the beverage receptacle around the pivot point
554 is a pivot point for the lid to be lifted from the beverage receptacle.
556 is the attachment point where the lid is attached to the handle of the beverage receptacle.
560 is the handle of the beverage receptacle.
570 is a removable beverage storage component.
580 is a holder for the removable beverage storage component.
600 is ornamental feature(s) on the wall of the beverage receptacle.

Fg is the force of gravity.

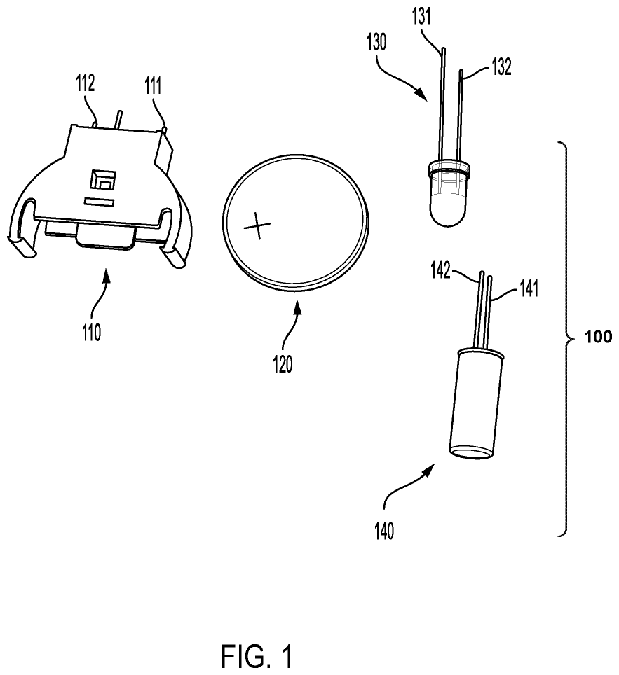

As shown in FIG. 1, the lighting apparatus comprises a power source (120); at least one light source (130); and a gravity switch having an on positional status and an off positional status (140) relative to the force of gravity. The power source, the light source, and the gravity switch are electrically connected in a circuit so that the light source emits light having a portion of its wavelengths in the visible spectrum when the gravity switch is in the on positional status.

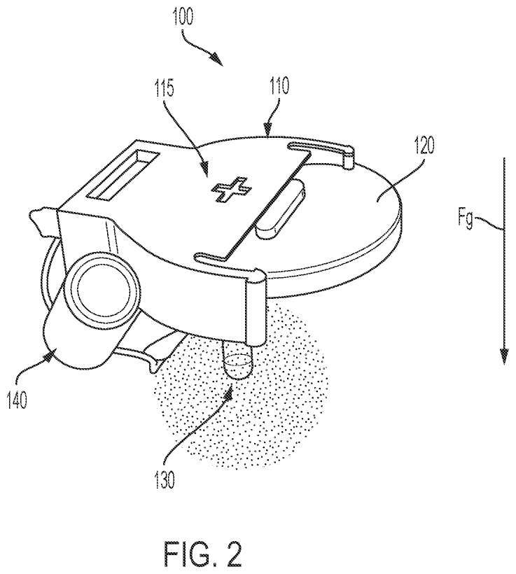

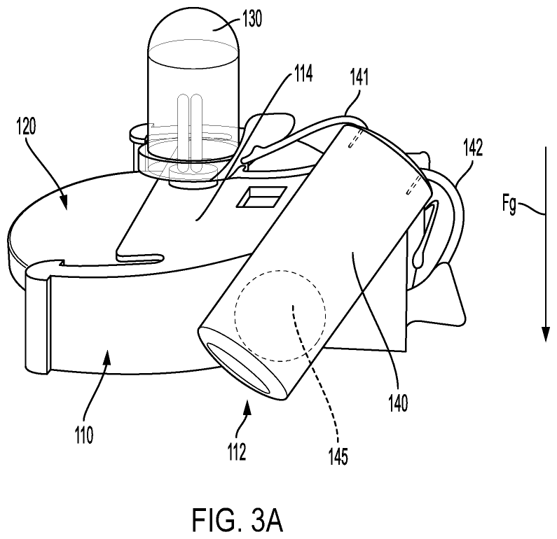

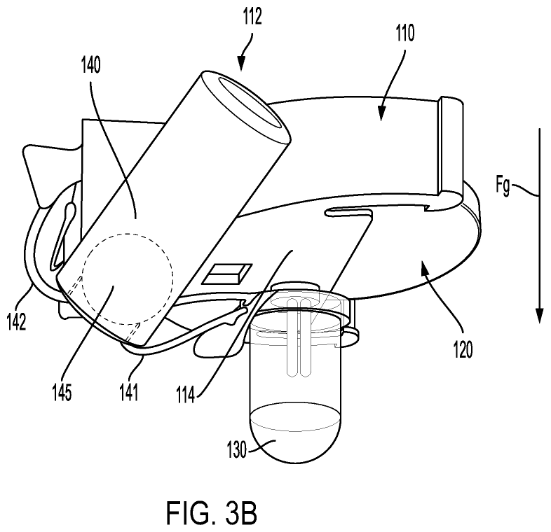

The embodiment of FIGS. 1, 2, 3A and 3B show the lighting apparatus comprising a typical battery holder which has at least two holder leads (111 and 112). One of the holder leads is electrically connected with one pole of the battery (pos. or neg.) with the other holder lead electrically connected to the other pole of the battery. One of the holder leads is electrically connected to one of the gravity switch leads (141 or 142). The other switch lead is electrically connected to one of the light leads (131 or 132) with the other light lead electrically connected to one of the holder leads so as to form the electrical circuit.

The light source can come in many forms, provided the light source emits light having wavelengths in the visible spectrum when the circuit is closed (i.e., the gravity switch is on). Bulbs, light emitting diodes (LED), conductive metal wires, incandescent bulbs, and fluorescent bulbs are examples of such light sources. If the light source is a light emitting diode it may be selected from the group consisting of white, single-colored, flickering (candle like), and multi-colored light emitting diodes.

The gravity switch is used to open the circuit (turn the light off) and close the circuit (turn the light on). As such, the gravity switch will have a positional on and positional off as it is arranged in the assembly.

The gravity switch often comprises a ball (145) inside a tube wherein the ball has a position in the tube relative to a force of gravity.

U.S. Pat. No. 4,467,154, the teachings of which are incorporated by reference herein in their entirety describes such a switch as a molded cup-shaped dielectric member and a cup-shaped conductor member are pressed together to comprise an integral dimensionally stable sealed enclosure for a contact member movable axially therein for selectively making or breaking an electrical connection between the cup-shaped conductor member and a second conductor extending axially through and sealed within the base of the cup-shaped dielectric member. The axially outer surfaces of the base and the second conductor comprise electrical contacts for a gravity actuated switch. The overall axial dimension between the axially outer surfaces is obtained by telescoping the cup-shaped members coaxially together until the preselected axial dimension is obtained. In one embodiment the cup-shaped dielectric member has a cylindrical base and a coaxial diametrically reduced cylindrical portion extending from the cup-shaped base to an upper opening. The conductor is telescoped over the diametrically reduced portion in fluid sealing relationship. The enclosure has an interior cylindrical surface of optimum diameter for the axially movable contact member comprising a metallic ball also of optimum diameter for any given size switch.

While the ball is electrically conductive, it may be comprised of a magnetic material, or the ball may not be comprised of a magnetic material, or at least may not be affected by a magnet.

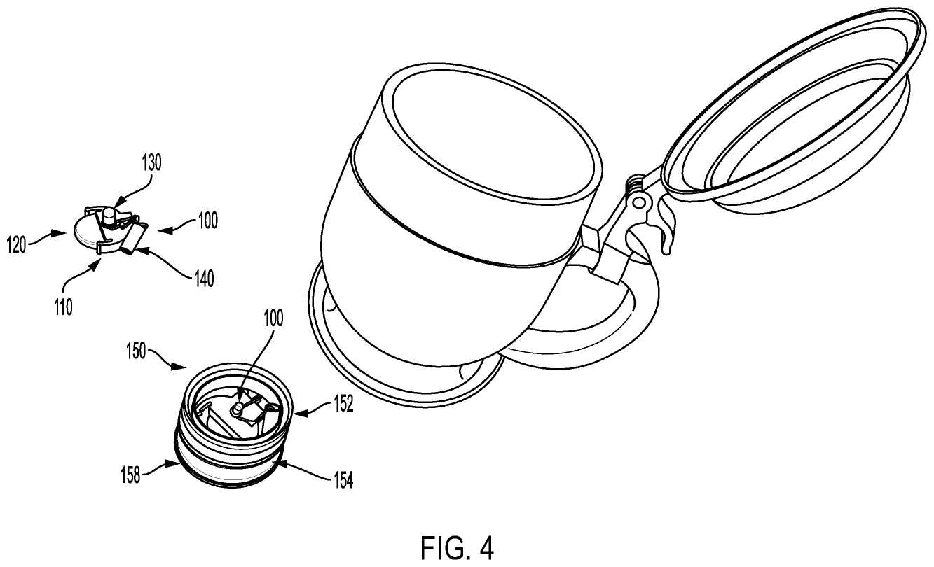

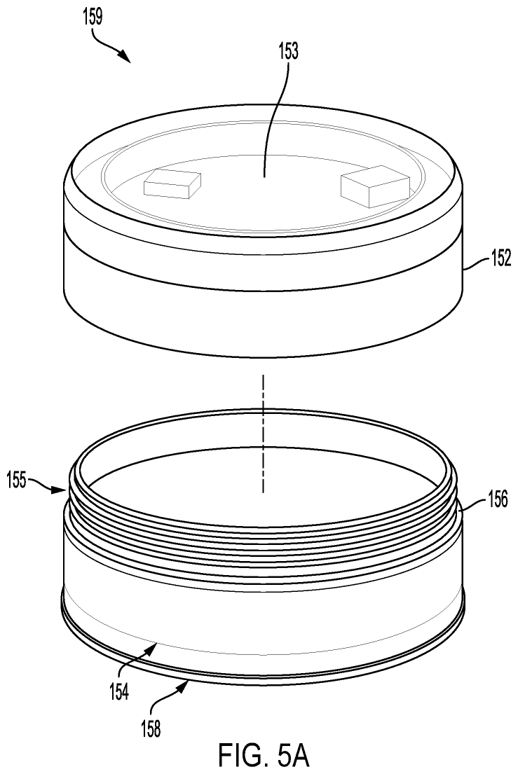

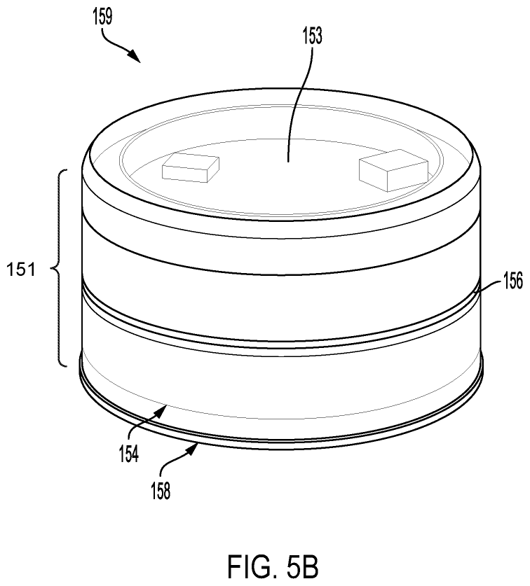

As shown in FIG. 4, and detailed in FIGS. 5A and 5B, the lighting apparatus is present as part of a lighting assembly (150) which has the lighting apparatus inside an enclosure formed by an enclosure top half (152), an enclosure base half (154) opposite the enclosure top half as a lighting assembly. As shown in FIG. 5A, the two halves are threadably engaged (155) with an O-ring or gasket (156) forming a seal between the top half and base half of the enclosure.

In this manner, the enclosure is water resistant at a submersible pressure. The submersible pressure is the pressure at which water will enter the enclosure when the sealed enclosure is submersed in water at 25° C. The submersible pressure is preferably at least 1 inch of water, with at least 2 inches more preferred, with at least 3 inches being more preferred and at least 8 inches of water being even more preferred.

The water resistance is important as some may wish to place the light in the beverage of a beverage receptacle or want to wash the enclosure. Should one want to wash the enclosure the gasket and enclosure materials should be chosen so that the enclosure's submersible pressure is maintained at 80° C., which is the maximum temperature of most dishwashers. The enclosure's submersible pressure should be at least 415 inches of water at 121° C. if autoclaving is desired.

The enclosure comprises a face (153), a base and at least one wall (151) running from the face to the base wherein at least a portion of the wavelengths emitted from the light source pass through the face and/or the at least one wall when the gravity switch is in the on positional status.

The enclosure may also comprise a magnet at the base half (158). In this instance, the ball of the gravity switch should be made of a material which is not affected by the magnet, i.e., the ball should be non-magnetic. In this manner, the position of the ball in the tube remains in the on positional status when the lid is closed.

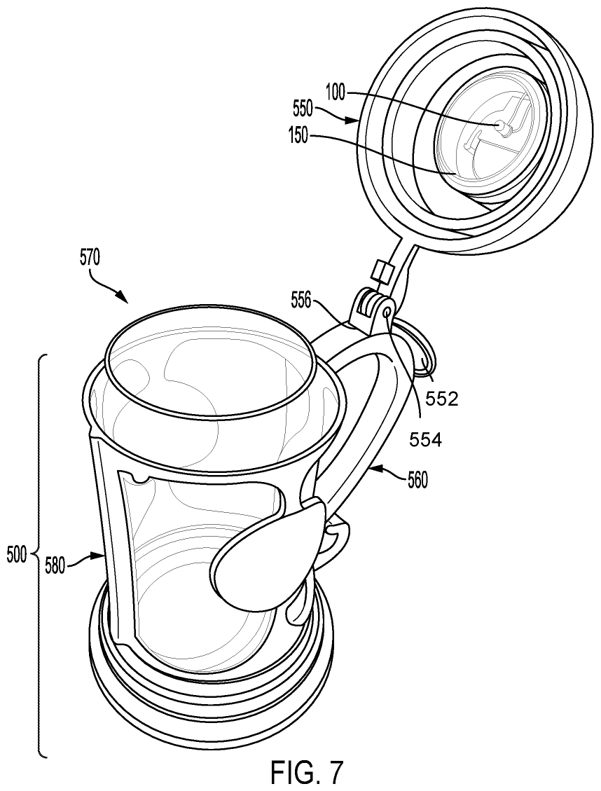

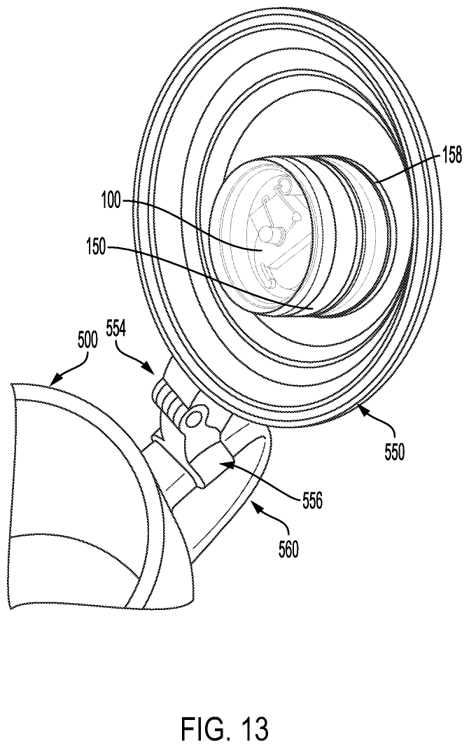

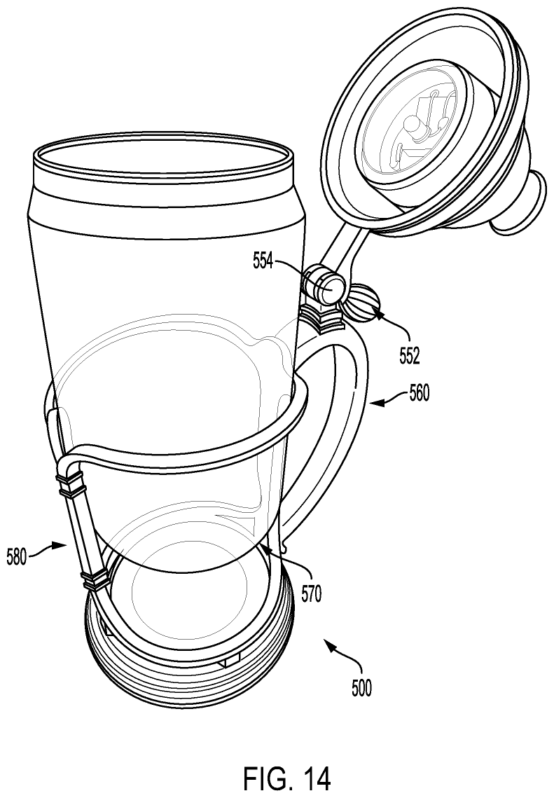

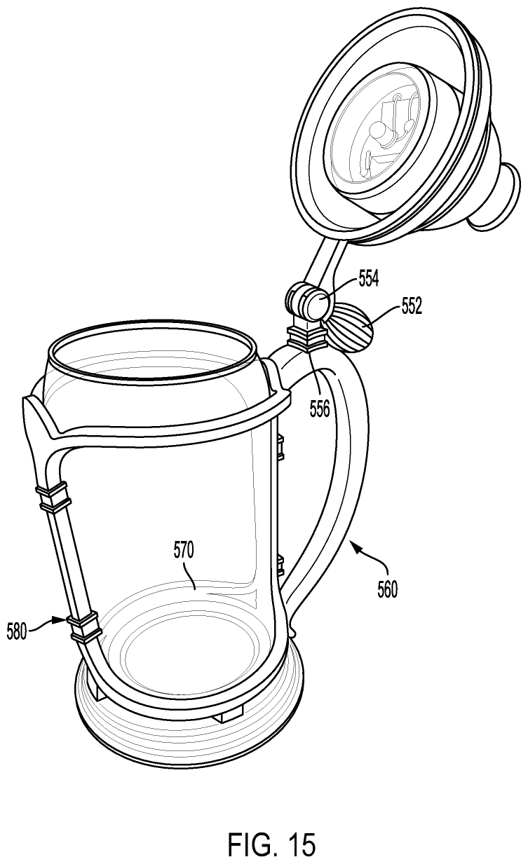

Once the lighting assembly is created it can be used in many ways. One way is to attach it to the lid of beverage receptacle as demonstrated in FIGS. 7 to 16.

FIG. 7 shows the lighting assembly attached to the beverage receptacle (500) known as a stein or beer stein. The stein typically has a handle (560). This handle is attached to a lid (550). In this case the handle is pivotally attached (552) to the lid at point (556). The lid has a cover side and lever (554). This embodiment is of a holder (580) with a removable beverage storage component (570).

A variant of FIG. 7 is a handled cup or handled mug. Instead of integrally attaching the lid with the lighting assembly with the handle, one could attach the lid to the handle with a clamping device like a U-bolt.

In one embodiment a device like a wire or cable clamp is used. The clamp has a hole on each end with a band connecting the two holes. The band is wrapped around the handle with a bolt passing through a first hole in the clamp, a hole in the lid at the pivot point (556), and the other hole in the clamp. The bolt is tightened making the lid pivotally attached to the handled mug.

If the lid is a magnetic metal, the base of the enclosure with the magnet can be magnetically attached to the lid.

The enclosure can be attached to the lid with hook and loop tape, two-sided tape, glue, epoxy or other adhesive, welding, soldering or suction cups.

As shown in FIG. 7, lighting assembly (150) having the lighting apparatus (100) is attached or affixed to the lid (550) so that the light source emits light into the beverage receptacle when the lid is placed on top of the beverage receptable. A typical beverage receptacle is like a glass which has a volume defined by a base, and a wall connected to the base with the end of the receptacle opposite the base being open or having a hole in which fluid can enter the beverage receptacle. Typically, the beverage receptacle is formed so that the hole lies in an opening plane perpendicular to the force of gravity.

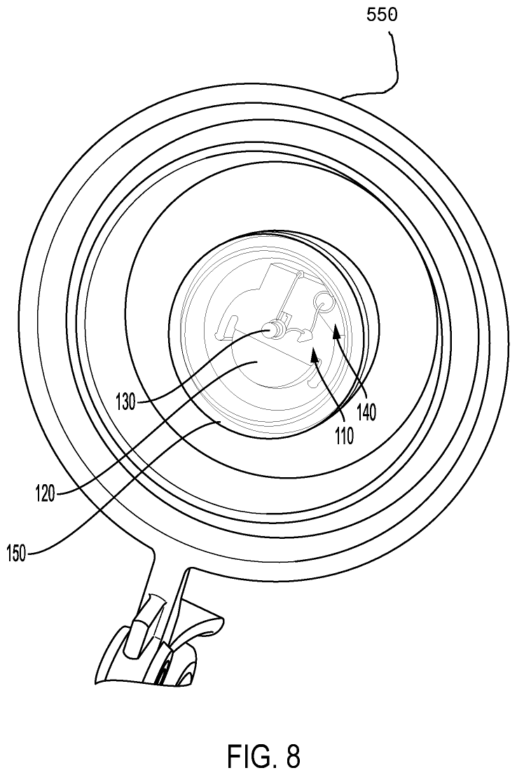

FIG. 8 is a blown-up view of just the lid with the lighting assembly affixed to the lid.

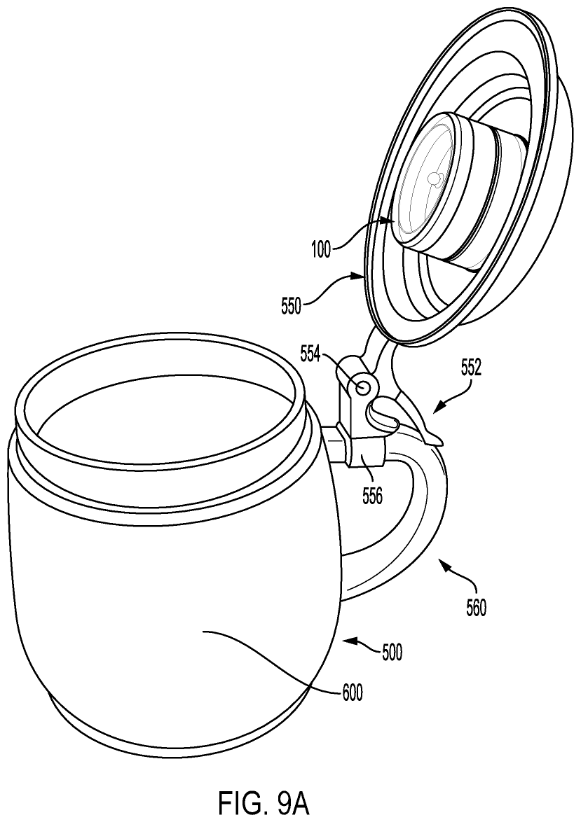

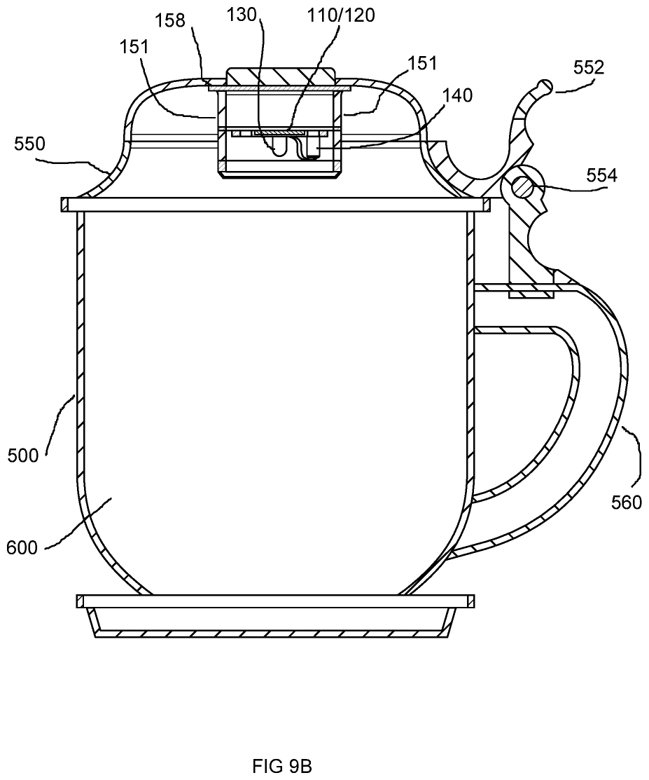

FIGS. 9A and 9B show another type of modified beverage receptacle having a lid. FIG. 9B is a cross sectional view of the beverage receptable in FIG. 9A.

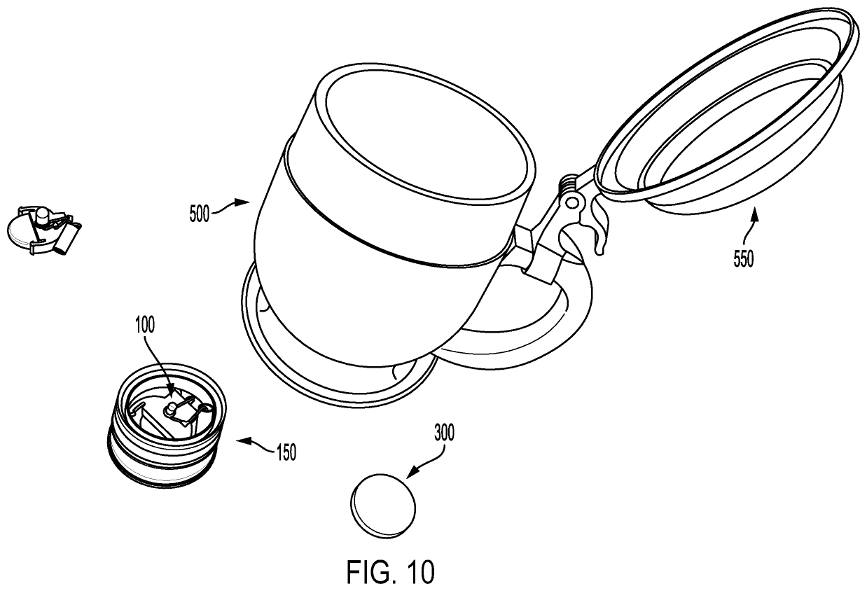

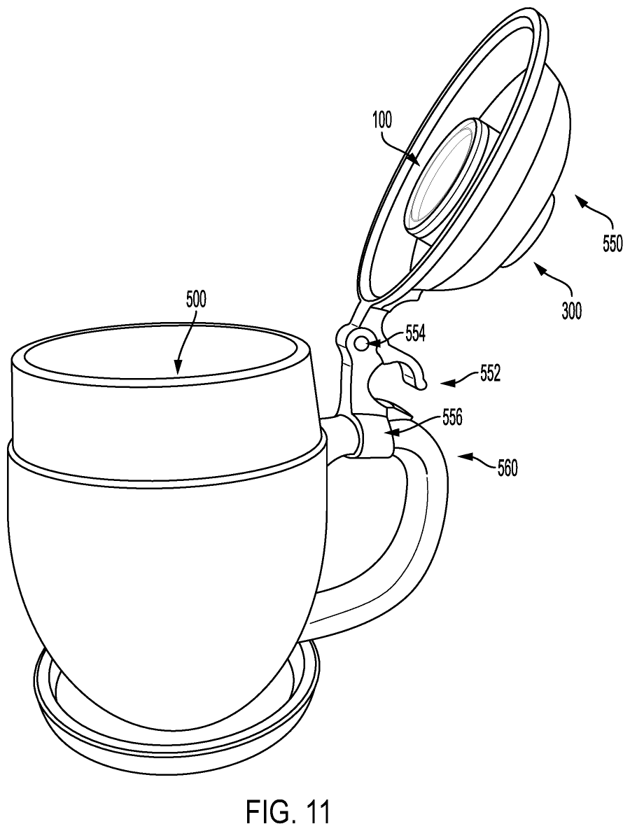

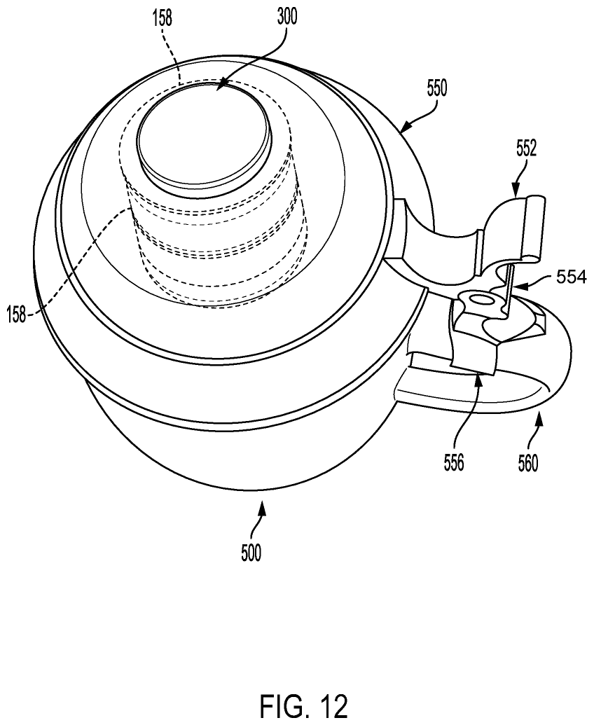

FIGS. 10, 11, and 12 demonstrate how to mount the lighting assembly having the magnet at its base. As noted in FIG. 10, (200) is a standalone magnet. As shown in FIGS. 11 and 12 the lid is between the magnet attached to the base of the enclosure and the stand-alone, or free-standing, magnet located on the side of the lid opposite the enclosure. In such a manner the lid is sandwiched between the magnet of the enclosure and the free-standing magnet.

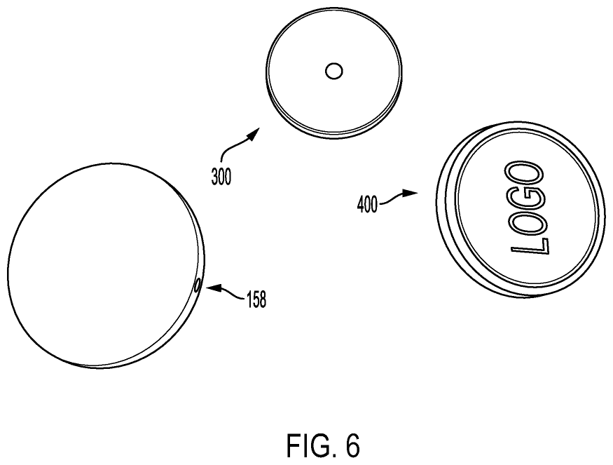

FIG. 6 shows the elements of magnetic display which is an accessory benefit of the lighting assembly. In this example a magnet has the letters LOGO on it, which can be replaced by a promotional demarcation such as a company logo. With the free-standing magnet attached to the lid on one side, this magnetic promotional item can be attached to the other side.

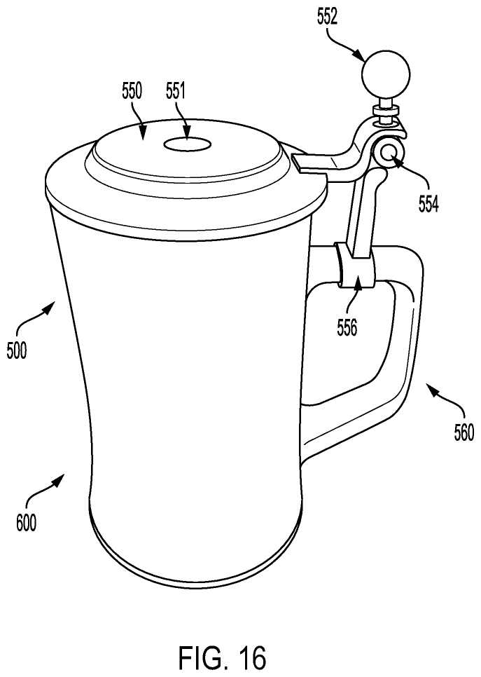

It is also believed that the enclosure base could further comprise a threaded post. This threaded post would pass through a hole in the lid (FIG. 16, (551)) and be secured with a mated thread device on the other side of the lid.

The base of the enclosure and the lid could also be of unitary construction, such as an injection molded or thermoset part.

The opening of the beverage receptacle forms an opening plane which is usually perpendicular to the force of gravity. When the lid, which has a lid plane, is placed over the opening of the beverage receptacle, it too is usually perpendicular to the force of gravity. When the lid is on the beverage receptacle opening the lid plane and the opening plane are typically parallel.

The gravity switch should be arranged so that it is in its positional on status when the lid plane and opening plane are perpendicular to the force of gravity and it is in its positional off status when there is an angle formed by the intersection of opening plane and the lid plane and the angle is greater than 80° and in its positional on status when the angle is less than 80°.

More preferably the gravity switch is in its positional off status when there is an angle formed by the intersection of opening plane and the lid plane and the angle is greater than 75° and in its positional on state when the angle is less than 25°.

It is even more preferable that the gravity switch is in its positional off state when there is an angle formed by the intersection of opening plane and the lid plane and the angle is greater than 70° and in its positional on state when the angle is less than 30°.

It can also be said the lid has a horizontal closed position when it is on top of the opening and a vertical open position, and the gravity switch is in the on positional status when the lid is in the horizontal closed position and the gravity switch is in the off positional status when the lid is in the horizontal closed position.

The beverage receptacle is selected from the group consisting of mugs, glasses, and cups.

We claim:

1. A lighting apparatus comprising
a power source;
at least one light source;
a gravity switch having an on positional status and an off positional status;
and
wherein the power source, the light source, and the gravity switch are electrically connected so that the light source emits light having wavelengths in the visible spectrum when the gravity switch is in the on positional status.

2. The lighting apparatus of claim 1 wherein the gravity switch comprises a ball inside a tube wherein the ball has a position in the tube relative to a force of gravity.

3. The lighting apparatus of claim 2, wherein the ball is comprised of a material which is not magnetic.

4. The lighting apparatus of claim 1, wherein the lighting apparatus is enclosed in an enclosure as a lighting assembly.

5. The lighting assembly of claim 4, wherein the enclosure is water resistant at a submersible pressure.

6. The lighting assembly of claim 5, wherein the submersible pressure is at least 1 inch of water.

7. The lighting apparatus of claim 1, wherein the at least one light source is a light emitting diode (LED).

8. The lighting assembly of claim 4, wherein the enclosure comprises a face on a top half, a base half and at least one wall connecting the face and the base half, wherein at least a portion of the wavelengths emitted from the light source pass through the face and/or the at least one wall when the gravity switch is in the on positional status.

9. The lighting assembly of claim 8, wherein the gravity switch comprises a ball inside a tube wherein the ball has a position in the tube relative to a force of gravity and a magnet is attached to the base half of the enclosure and the position of the ball in the tube during the on positional status is not affected by the magnet.

10. The lighting assembly of claim 9, wherein the base half of the enclosure is attached to a lid of a beverage receptacle creating a lighted beverage receptacle.

11. The lighted beverage receptacle of claim 10, wherein the lid has a horizontal closed position and a vertical open position and the gravity switch is in the on positional status when the lid is in the horizontal closed position and the gravity switch is in the off positional status when the lid is in the horizontal closed position.

12. The lighted beverage receptacle of claim 11, wherein the base half of the enclosure is magnetically attached to the lid.

13. The lighted beverage receptacle of claim 11, wherein the lid is between the magnet attached to the base half of the enclosure and a magnet on a side of the lid opposite the enclosure.

14. The lighted beverage receptacle of claim 13 wherein the magnet on the side of the lid opposite the enclosure is attached to a cap bearing a promotional demarcation.

15. The lighted beverage receptacle of claim 11, wherein the base half of the enclosure is affixed to the lid.

16. The lighted beverage receptacle of claim 11, wherein the base half of the enclosure further comprises a threaded post passing through a hole in the lid and secured with a mated thread device.

17. The lighted beverage receptacle of claim 11, wherein the base half of the enclosure and the lid are of unitary construction.

18. The lighting apparatus of claim 11, wherein the lid is attached to a handle of the beverage receptacle.

19. The lighted beverage receptacle of claim 11, wherein the beverage receptacle is a stein.

20. The lighted beverage receptacle of claim 11, wherein the beverage receptacle is selected from the group consisting of mugs, glasses, and cups.
